(19) United States
(12) Patent Application Publication
(10) Pub. No.: US 2012/0207088 A1
(43) Pub. Date: Aug. 16, 2012

(54) METHOD AND APPARATUS FOR UPDATING METADATA

(75) Inventors: Hang Liu, Yardley, PA (US); Xavier De Foy, Kirkland (CA)

(73) Assignee: INTERDIGITAL PATENT HOLDINGS, INC., Wilmington, DE (US)

(21) Appl. No.: 13/369,657

(22) Filed: Feb. 9, 2012

Related U.S. Application Data
(60) Provisional application No. 61/441,968, filed on Feb. 11, 2011.
(60) Provisional application No. 61/441,861, filed on Feb. 11, 2011.

(51) Int. Cl. H04W 4/00

(52) U.S. Cl. 370/328

(57) ABSTRACT

A method and apparatus are described for updating metadata, (e.g., media presentation descriptions (MPDs)). A wireless transmit/receive unit (WTRU) may transmit a hypertext transport protocol (HTTP) request message and receive an HTTP response message including metadata requested by the HTTP request message. The WTRU may then register with at least one server to establish a metadata update service based on information included in the metadata. The WTRU may fetch updated metadata in response to receiving a metadata update signal provided by the metadata update service. The information may identify a uniform resource identifier (URI) or a fully qualified domain name (FQDN) associated with an event server used to provide the metadata update service.

### CROSS REFERENCE TO RELATED APPLICATIONS

This application claims the benefit of U.S. Provisional Application No. 61/441,968 filed Feb. 11, 2011, and U.S. Provisional Application No. 61/441,861 filed Feb. 11, 2011, the contents of which are hereby incorporated by reference herein.

### BACKGROUND

Dynamic adaptive streaming over hypertext transfer protocol (HTTP) was developed in the third generation partnership project (3GPP) as part of a packet switch streaming feature. A media presentation description (MPD), (i.e., metadata), may be obtained, (e.g., downloaded), by an HTTP streaming client in a wireless transmit/receive unit (WTRU), (i.e., a mobile station), and may be frequently updated by a service provider during a live streaming session.

A WTRU may use a pull-based method to update its MPD, whereby the server is polled in an attempt to fetch a new MPD at regular intervals, whenever the WTRU runs out of media segments, or when an error occurs. If the WTRU receives an HTTP response error when it requests a media segment, the WTRU may check whether the precision of the time synchronization to a globally accurate time standard is sufficiently accurate. In the case of repeated errors where the time standard is believed accurate, or the re-occurrence of errors after any correction, the WTRU may check for an update of the MPD.

There are several drawbacks for this polling approach. It is possible that the MPD may have not been updated as of yet and the client receives an old MPD when the WTRU polls the server. Furthermore, polling generates extra traffic. Alternatively, when an MPD is updated, the WTRU may not poll and receive the updated MPD on time as required. The delay in obtaining an updated MPD may make it difficult to access media and provide seamless media playout. Furthermore, when the WTRU receive an indication of an HTTP response error for its request for a media segment, the WTRU may not know the reason for the error.

### SUMMARY

A method and apparatus are described for updating metadata, (e.g., media presentation descriptions (MPDs)). A wireless transmit/receive unit (WTRU) may transmit a hypertext transport protocol (HTTP) request message and receive an HTTP response message including metadata requested by the HTTP request message. The WTRU may then register with at least one server to establish a metadata update service based on information included in the metadata. The WTRU may fetch updated metadata in response to receiving a metadata update signal provided by the metadata update service. The information may identify a uniform resource identifier (URI) or a fully qualified domain name (FQDN) associated with an event server used to provide the metadata update service.

### BRIEF DESCRIPTION OF THE DRAWINGS

A more detailed understanding may be had from the following description, given by way of example in conjunction with the accompanying drawings wherein:

FIG. 1A shows an example communications system in which one or more disclosed embodiments may be implemented;

FIG. 1B shows an example wireless transmit/receive unit (WTRU) that may be used within the communications system shown in FIG. 1A;

FIG. 1C shows an example radio access network and an example core network that may be used within the communications system shown in FIG. 1A;

FIG. 2A shows an example of a system architecture for performing progressive download and dynamic adaptive streaming over hypertext transport protocol (HTTP);

FIG. 2B shows an example of message exchanges when signaling an MPD update to a WTRU with an HTTP streaming client in the system architecture of FIG. 2A;

FIGS. 3A and 3B show examples of HTTP response messages;

FIGS. 4A and 4B shows MPD element or attribute names and descriptions;

FIG. 5 shows a signal flow diagram of an example procedure for establishing communication and updating an MPD;

FIG. 6 shows a signal flow diagram of an example procedure using two WTRUs that register to a time synchronization service with the same group identity (ID);

FIG. 7 shows a signal flow diagram of an example procedure for re-synchronizing WTRUs;

FIG. 8 shows an MPD element or attribute name and description of a content instance ID attribute;

FIG. 9 shows an MPD element or attribute name and description of a content ID attribute; and

FIG. 10 shows an example block diagram of a WTRU used to perform the procedures of FIGS. 5-7.

### DETAILED DESCRIPTION

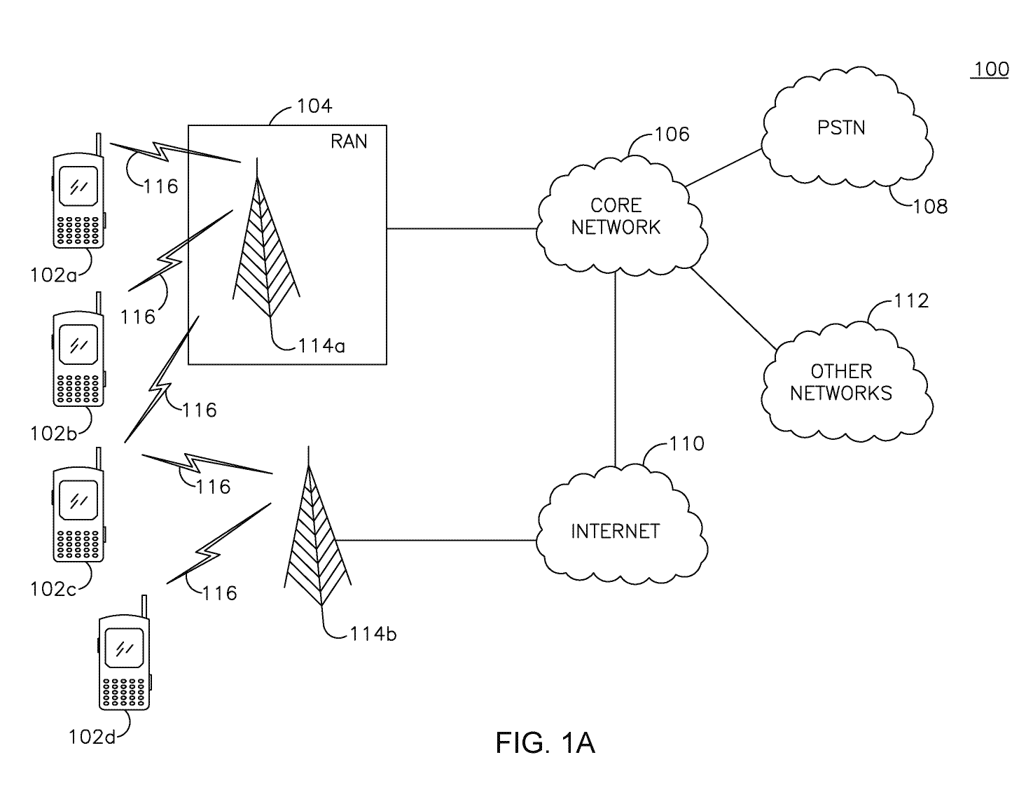

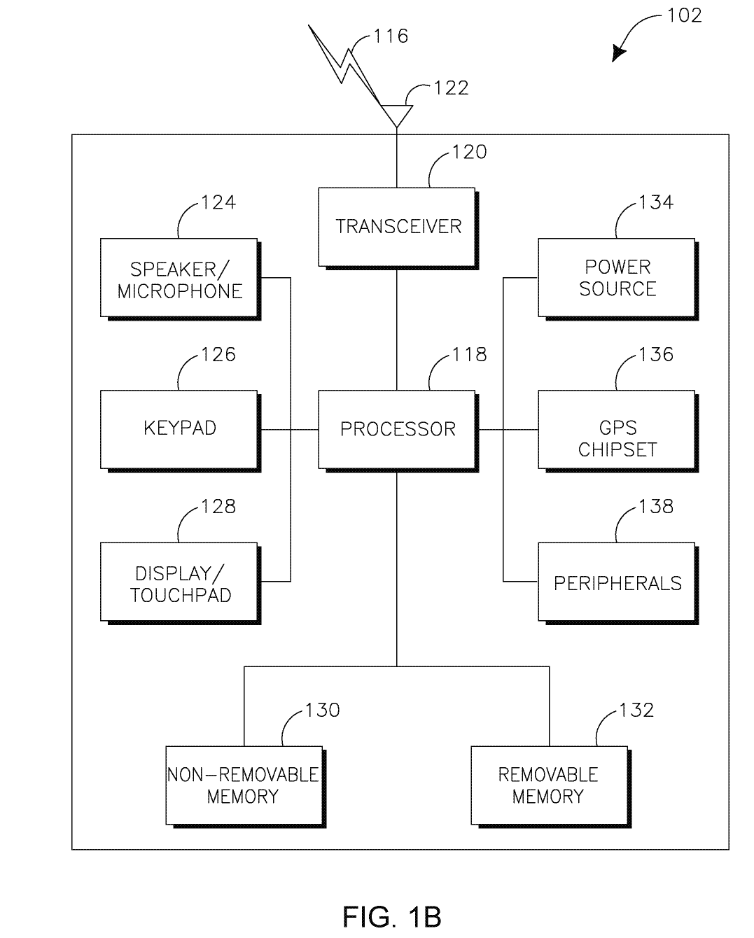

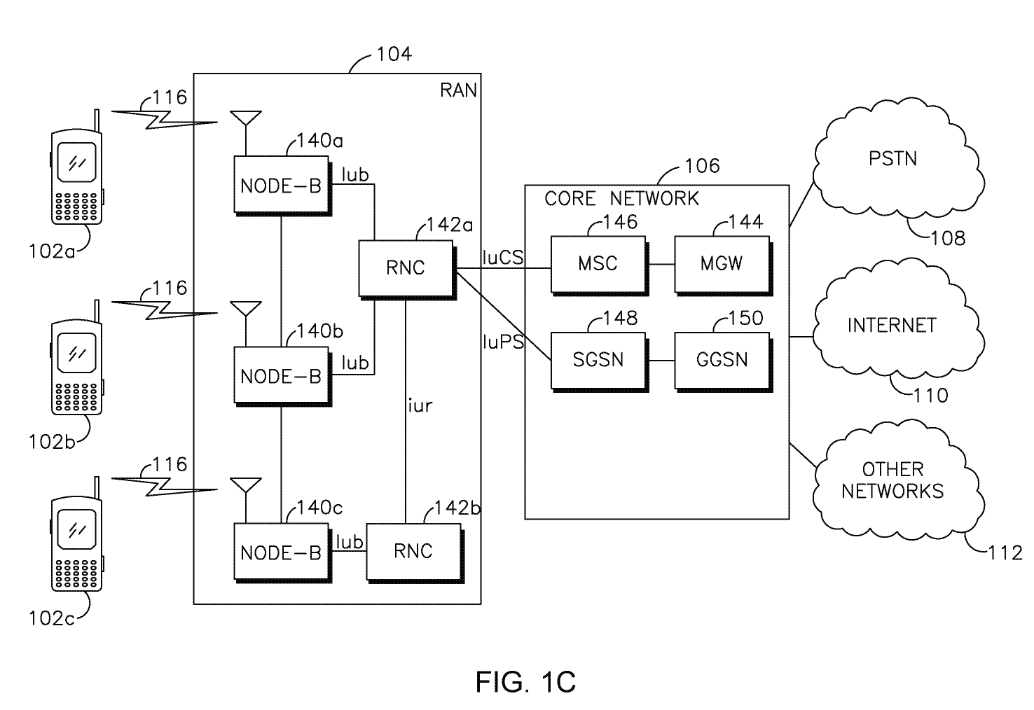

FIG. 1A shows an example communications system 100 in which one or more disclosed embodiments may be implemented. The communications system 100 may be a multiple access system that provides content, such as voice, data, video, messaging, broadcast, and the like, to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include WTRUs 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an evolved Node-B (eNB), a Home Node-B (HNB), a Home eNB (HeNB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link, (e.g., radio frequency (RF), microwave, infrared (IR), ultraviolet (UV), visible light, and the like). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as universal mobile telecommunications system (UMTS) terrestrial radio access (UTRA), which may establish the air interface 116 using wideband CDMA (WCDMA). WCDMA may include communication protocols such as high-speed packet access (HSPA) and/or evolved HSPA (HSPA+). HSPA may include high-speed downlink packet access (HSDPA) and/or high-speed uplink packet access (HSUPA).

In another embodiment, the base station 114a and the WTRUs 102a, 102b, 102c may implement a radio technology such as evolved UTRA (E-UTRA), which may establish the air interface 116 using long term evolution (LTE) and/or LTE-Advanced (LTE-A).

In other embodiments, the base station 114a and the WTRUs 102a, 102b, 102c may implement radio technologies such as IEEE 802.16 (i.e., worldwide interoperability for microwave access (WiMAX)), CDMA2000, CDMA2000 1X, CDMA2000 evolution-data optimized (EV-DO), Interim Standard 2000 (IS-2000), Interim Standard 95 (IS-95), Interim Standard 856 (IS-856), global system for mobile communications (GSM), enhanced data rates for GSM evolution (EDGE), GSM/EDGE RAN (GERAN), and the like.

The base station 114b in FIG. 1A may be a wireless router, HNB, HeNB, or AP, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT, (e.g., WCDMA, CDMA2000, GSM, LTE, LTE-A, and the like), to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over Internet protocol (VoIP) services to one or more of the WTRUs 102a, 102b, 102c, 102d. For example, the core network 106 may provide call control, billing services, mobile location-based services, pre-paid calling, Internet connectivity, video distribution, and the like, and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the Internet protocol (IP) in the TCP/IP suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B shows an example WTRU 102 that may be used within the communications system 100 shown in FIG. 1A. As shown in FIG. 1B, the WTRU 102 may include a processor 118, a transceiver 120, a transmit/receive element, (e.g., an antenna), 122, a speaker/microphone 124, a keypad 126, a display/touchpad 128, a non-removable memory 130, a removable memory 132, a power source 134, a global positioning system (GPS) chipset 136, and peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a microprocessor, one or more microprocessors in association with a DSP core, a controller, a microcontroller, an application specific integrated circuit (ASIC), a field programmable gate array (FPGA) circuit, an integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, ITV, or visible light signals, for example. In yet another embodiment, the transmit/receive element 122 may be configured to transmit and receive both RF and light signals. The transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122, (e.g., multiple antennas), for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station, (e.g., base stations 114a, 114b), and/or determine its location based on the timing of the signals being received from two or more nearby base stations. The WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C shows an example RAN 104 and an example core network 106 that may be used within the communications system 100 shown in FIG. 1A. As noted above, the RAN 104 may employ UTRA radio technology to communicate with the WTRUs 102a, 102b, 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. The RAN 104 may include any number of Node-Bs and RNCs.

As shown in FIG. 1C, the Node-Bs 140a, 140b may communicate with one another and with the RNC 142a via respective Iub interfaces. Additionally, the Node-B 140c may communicate with the RNC 142b via an Iub interface. Each of the RNCs 142a, 142b may be configured to control the respective Node-Bs 140a, 140b, 140c to which it communicates with. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 1C may include a media gateway (MGW) 144, a mobile switching center (MSC) 146, a serving general packet radio service (GPRS) support node (SGSN) 148, and/or a gateway GPRS support node (GGSN) 150. While each of the foregoing elements are depicted as part of the core network 106, any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

In progressive download and dynamic adaptive streaming over HTTP (DASH), it is critical that a WTRU with an HTTP streaming client downloads and updates an MPD in an efficient, reliable and timely manner. Signaling a WTRU that an MPD update is needed and instructing the WTRU's client to update the MPD are described herein. For example, if the service provider desires to insert an advertisement or an announcement during the session, the MPD may be updated accordingly. Alternatively, if a server goes offline, the service provider may update the MPD to migrate the services.

MPDs may be configured to contain information used to construct appropriate uniform resource identifiers (URIs) or fully qualified domain names (FQDNs), to access media segments and to provide streaming services to the WTRU users. An MPD may include an extensible markup language (XML) document which contains metadata describing media streaming representations, such as different bitrates, languages, resolutions, and the like.

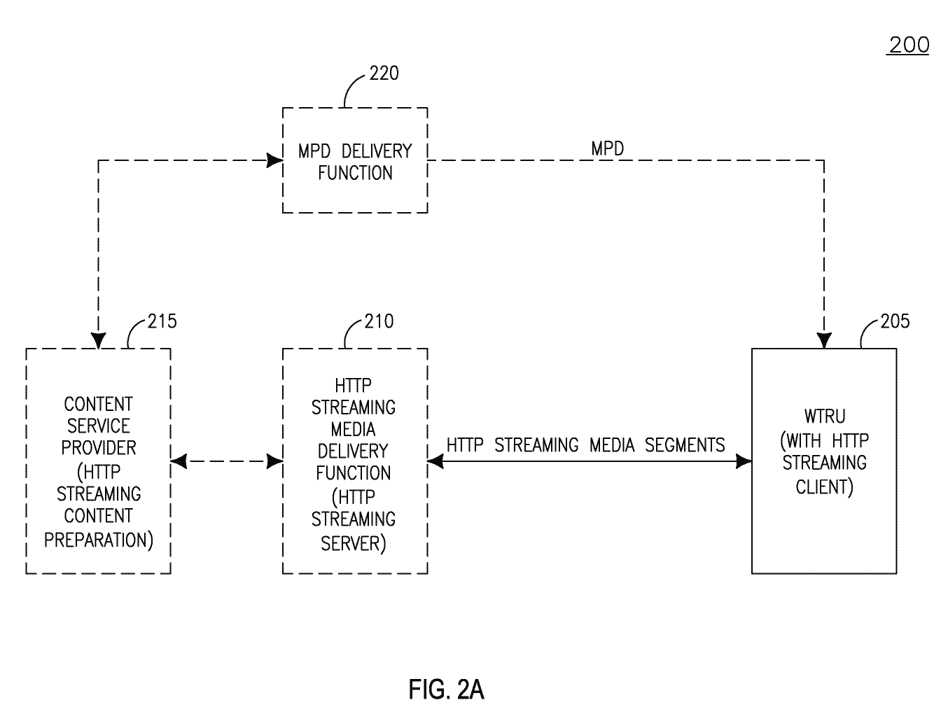

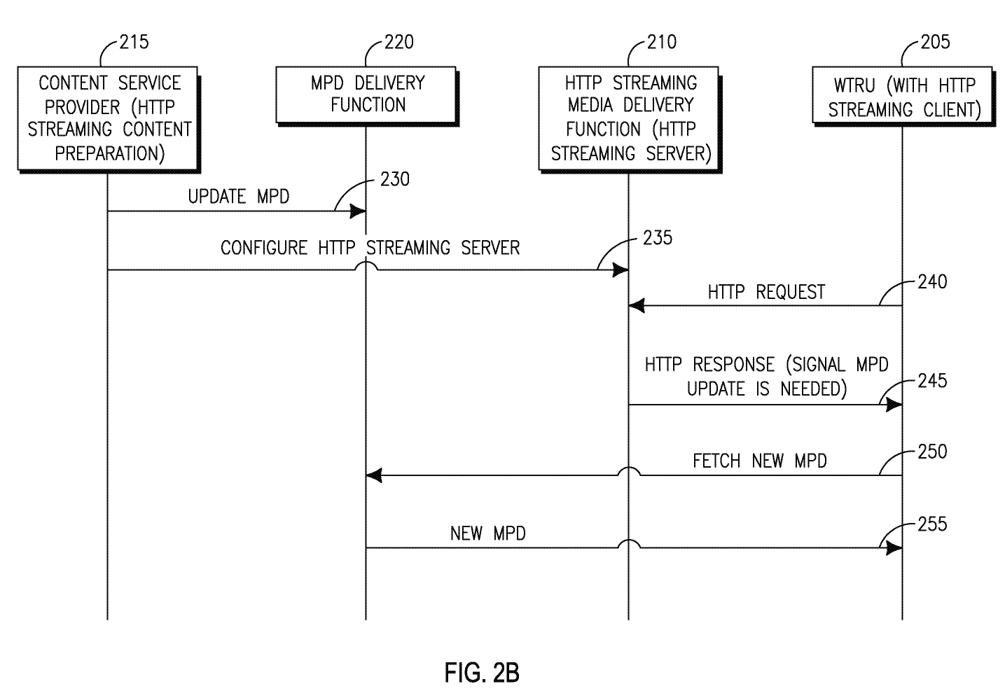

FIG. 2A shows an example of a system architecture 200 for performing progressive download and dynamic adaptive streaming over HTTP. The system architecture 200 may include a WTRU 205 with an HTTP streaming client having access to an MPD that provides information for the WTRU 205 to download media segments from one or more HTTP servers, and renders the downloaded media appropriately so as to provide the streaming service to a user of the WTRU 205. The system architecture 200 may further include an HTTP media delivery function 210, a content service provider 215 and an MPD delivery function 220.

To provide the streaming service to the user, the WTRU 205 may download an MPD, and then download media data based on the MPD. The MPD may be updated during a streaming session. The WTRU 205 may download the updated MPD in an efficient, reliable, and timely manner in order to provide acceptable streaming service to the user. A method and apparatus for signaling the requirement of an MPD update to the WTRU 205, and instructing the WTRU 205 to fetch new MPDs, are described herein.

FIG. 2B shows message exchanges when signaling the MPD update to the WTRU 205 in the system architecture 200 of FIG. 2A. When an MPD update is needed and the new MPD becomes available, the content service provider 215 responsible for content preparation may provide the new MPD to the MPD delivery function 220 (230), and configure the HTTP streaming media delivery function 210, (i.e., HTTP streaming server), with automatic or manual configuration (235). When the WTRU 205 sends an HTTP request message 240 to the HTTP streaming media delivery function 210, which requested the HTTP streaming media delivery function 210 to download a media segment associated with a URI or an FQDN that was provided in the current MPD, the HTTP streaming media delivery function 210 may send an HTTP response message 245 to the WTRU 205 instructing the WTRU 205 to fetch the new MPD (250 and 255).

In one embodiment, the HTTP streaming media delivery function 210 (i.e., HTTP streaming server) may include an MPD update in the HTTP response message 245 after receiving the HTTP request message 240 from the WTRU 205. The HTTP response message 245 may include a status-line, general header, response-header, entity header, and message body. The status-line may include a protocol version followed by a numeric status code and its associated textual phrase. The response-header may allow the HTTP streaming media delivery function 210 to pass additional information about the response which cannot be placed in the status-line, such as information about the HTTP streaming media delivery function 210 and about further access to the resource identified by the HTTP request message 240, (identified by a URI or an FQDN). The response-header may contain fields such as an accept-ranges field, an age field, an etag field, a location field, a proxy-authenticate field, a retry-after field, a server field, a vary field, a www-authenticate field, and the like. The HTTP request message 240 and the HTTP response message 245 may transfer an entity including entity-header fields and an entity-body, although some HTTP response messages 245 may only include the entity-header fields.

To signal the WTRU 205 that an event requiring an MPD update has occurred, the HTTP streaming media delivery function 210, (i.e., HTTP streaming server), may use one of the following procedures to send an HTTP response message 245 when it receives an HTTP request message 240 from a WTRU. The MPD update signal event in the HTTP response message 245 from the HTTP streaming media delivery function 210 may be associated with all media segments at the time that a new MPD is required, or with one particular media segment across all of its representations. For example, an MPD update event may be associated with every response for a media segment starting at 10:30′30″ of a live event.

The HTTP streaming media delivery function 210 may send an HTTP response message 245 with a status code of “informational class” (1XX), (e.g., a status code of “continue” (100)). The HTTP streaming media delivery function 210 may include an entity to inform the WTRU 205 that an MPD update is needed, and contains one or more resource characteristics and at least one location corresponding to the new MPD in the HTTP response message 245, from which the WTRU 205 may choose the most appropriate one. The HTTP streaming media delivery function 210 may further specify the latest MPD update time by which the MPD update may be performed. The WTRU 205 may choose to update the MPD any time between the current time and the latest MPD update time.

In addition, the HTTP streaming media delivery function 210 may include the recommended download location of the new MPD in the location field of the response header and/or the content location field of the entity header in the HTTP response message 245 if the HTTP streaming media delivery function 210 has a preferred choice. Alternatively, the HTTP streaming media delivery function 210 may send the updated MPD as an entity in the HTTP response message 245. The original media segment request may be fulfilled after this informational response. If the WTRU 205 receives an HTTP response message 245 with an informational class status code for the request, it may analyze information in the HTTP response message 245. If the HTTP response message 245 contains the information to instruct the WTRU 205 to download a new MPD, the WTRU 205 may download the new MPD as instructed. The WTRU 205 may verify if the update event is current, and ignore it if its current MPD copy is more recent than the advertised update, (e.g., a WTRU replaying an older sequence may ignore MPD update 10:30′30″ if its MPD copy was fetched at 10:31′00′)′. The WTRU 205 may use the new MPD for continuing to fetch the media segments after it downloads the new MPD.

The HTTP streaming media delivery function 210 may send a status code of “success class” (2XX) in the HTTP response message 245. For example, the HTTP streaming media delivery function 210 may send an HTTP response message 245 with a status code “OK” (200) or a status code “created” (201). The HTTP streaming media delivery function 210 may send a HTTP response message 245 with multiple parts that enables the encapsulation of one or more entities within a single multipart-message body. One part in the message may be used to convey the MPD update, while another part may contain the normal response body, (e.g., the requested media segment). The HTTP streaming media delivery function 210 may include an entity to instruct the WTRU 205 to download the updated MPD and contains one or more resource characteristics and location(s) corresponding to the new MPD in the HTTP response message 245 from which the WTRU 205 may choose the most appropriate one. The HTTP streaming media delivery function 210 may further specify the latest MPD update time by which the MPD update may be updated. The WTRU 205 may choose to update the MPD any time between the current time and the latest MPD update time.

In addition, the HTTP streaming media delivery function 210 may include the recommended download location of the new MPD in the location field of the response header and/or the content location field of the entity header in the response message if the HTTP streaming media delivery function 210 has a preferred choice. The HTTP streaming media delivery function 210 may also send the updated MPD in an entity of the HTTP response message 245. If the WTRU 205 receives an HTTP response message 245 with a success class status code for the HTTP request message 240, it may analyze information in the HTTP response message 245. If the HTTP response message 245 contains the information to instruct the WTRU 205 to download a new MPD, it may download the new MPD as instructed. The WTRU 205 may verify if the update event is current, and ignore it if its current MPD copy is more recent than the advertised update. The WTRU 205 may use the new MPD for continuing to fetch the media segments after it downloads the new MPD.

The HTTP streaming media delivery function 210 may use a status code of “redirection class” (3XX) in the HTTP response message 245. The HTTP streaming media delivery function 210 may include an entity containing one or more resource characteristics and location(s) corresponding to the new MPD in the HTTP response message 245, from which the WTRU 205 may choose the most appropriate one. The HTTP streaming media delivery function 210 may also include the recommended download location of the new MPD in the location field of the response header and/or the content location field of the entity header in the response message if the HTTP streaming media delivery function 210 has a preferred choice. If the WTRU 205 receives an HTTP response message 245 with a status code of “redirection class” (3XX)), it may analyze the information in the HTTP response message 245, (e.g., resource characteristics such as file type and locations). If the resource is a new MPD, it may download the new MPD from the appropriate location. The WTRU 205 may use the new MPD for continuing to fetch the media segments once it downloads the new MPD.

The HTTP streaming media delivery function 210 may intentionally send a status code of “WTRU error class” (4XX) in the HTTP response message 245. The HTTP streaming media delivery function 210 may also include an entity containing an explanation of the error situation, indicating that a new MPD is required. The location of the new MPD may also be included in the entity. The HTTP streaming media delivery function 210 may also include the recommended download location of the new MPD in the location field of the response header and/or the content location field of the entity header in the HTTP response message 245 if the HTTP streaming media delivery function 210 has a preferred choice. Alternatively, the HTTP streaming media delivery function 210 may send the updated MPD as an entity in the HTTP response message 245. If the WTRU 205 receives an HTTP response message 245 with the “WTRU error class” status code, it may analyze the information in the HTTP response message 245 and check for an update of the MPD, if necessary. The WTRU 205 may use the new MPD for continuing to fetch the media segments once it downloads the new MPD.

The HTTP streaming media delivery function 210 may intentionally send a status code of “server error class” (5XX) in the HTTP response message 245. The HTTP streaming media delivery function 210 may also include an entity containing an explanation of the error situation, indicating that a new MPD is required. The location of the new MPD may also be included in the entity. The HTTP streaming media delivery function 210 may also include the recommended download location of the new MPD in the location field of the response header and/or the content location field of the entity header in the HTTP response message 245. The HTTP streaming media delivery function 210 may also send the updated MPD as an entity in the HTTP response message 245. If the WTRU 205 receives an HTTP response message 245 with the “server error” status code, it may analyze information in the HTTP response message 245 and check for an update of the MPD if necessary. The WTRU 205 may use the new MPD for continuing to fetch the media segments once it downloads the new MPD.

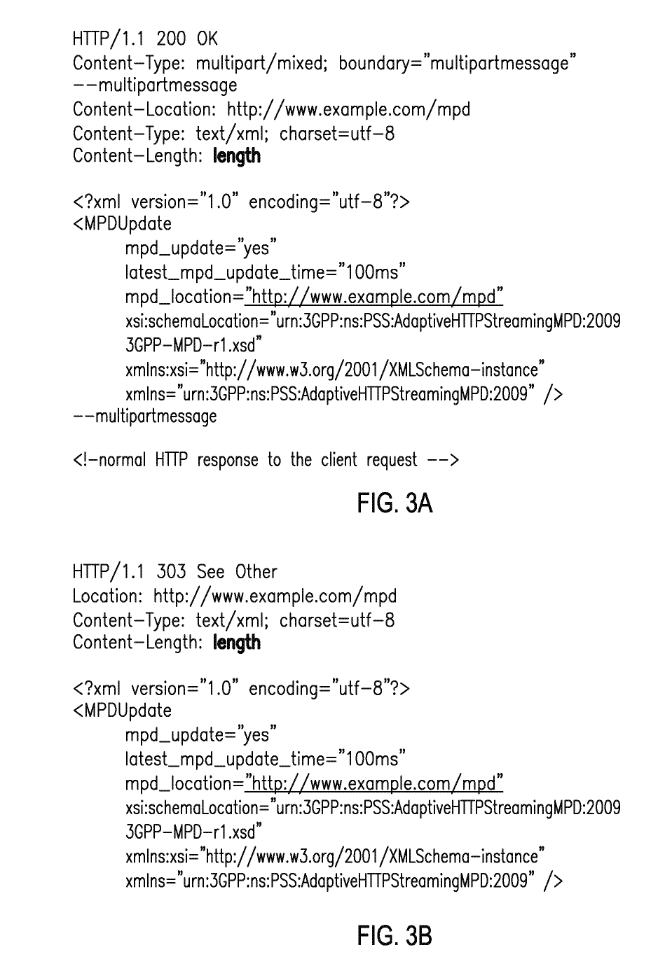

FIG. 3A shows an example HTTP response message 245 with which the HTTP streaming media delivery function 210 may use a status code of success class (2XX) and includes multiple parts in the response, one part to signal the event that a MPD update is needed and the other part for normal response to the WTRU request.

FIG. 3B shows another example HTTP response message 245 with which the HTTP streaming media delivery function 210 may use a status code of redirection class (3XX) and includes an explanation in the response to signal the event that a MPD update is needed. Alternatively, the HTTP streaming media delivery function 210 may use a status code of informational class (1XX), client error class (4XX) or server error class (5XX) with an explanation of the situation in the response to signal the event that an MPD update is needed.

An MPD may be relatively large. For example, many representations are offered to support WTRUs operating on channels with a wide range of bandwidths and channel conditions and obfuscated playlists are used. The minimum update period may be set to on the order of 10 seconds to enable finding out the location of the latest media segment, so that the WTRU is not too far behind live encoding. For this scenario, the MPD may be of significant size to initially download, and a significant proportion of the bandwidth of the service may be spent transferring the MPD every 10 seconds. Thus, the vast majority of MPDs are unchanged at each update.

The current polling mechanism, (even if mitigated by transmitting the MPD update in a “diff” format), is inefficient in term of bandwidth usage, and introduces a delay between MPD publication and consumption. In addition to polling, the WTRU may fetch the MPD at any time, (e.g., when the HTTP streaming media delivery function 210 returns an HTTP error code while fetching a media segment).

An event-based mechanism may be provided to signal MPD updates by adding an element in the MPD to enable the creation of a bidirectional link between a WTRU and a server. Basically, the WTRU 205 may obtain an end point identifier, (e.g., a URI or an FQDN), to a bidirectional service from the MPD to use the bidirectional service. To do so, the WTRU 205 may open the provided service end point URI or FQDN using the appropriate protocol. While this service end point may be dedicated to this MPD, the same service end point may be provided for many MPDs. Additional information provided in the MPD, (such as service ID), may then be used to register for one particular service, which may be specific or not to the MPD. In one particular type of server that provides MPD update event service, a bidirectional link may be used by the server to signal MPD updates to WTRUs. A bidirectional communication procedure may be based on existing HTTP/1.1 bidirectional techniques, such as long polling, WebSocket protocol, a presence protocol, (e.g., extensible messaging and presence protocol (XMPP)), or a web service protocol such as simple object access protocol (SOAP). The existence of a bidirectional link may enable additional services to be provided by the server to the WTRUs, (e.g., synchronization between flows to different devices, saving/retrieving bookmarks from different devices and users, interactive and social networking among WTRUs, such as chat, instant Messaging, and the like).

New elements and attributes in the MPD are introduced herein, and the associated processing in the WTRU 205 to use this information to connect to a control channel for a particular set of services. Input from the service may be used to influence the WTRU's application behavior using an MPD update event and an inter-device time synchronization service.

In an alternate embodiment, the bidirectional service may not be linked in an MPD. Instead, the WTRU 205 may learn about the service endpoint through another means, such as a web portal. Generic service type may also be learned through the same means, (e.g., MPD update event service, inter-device synchronization service, and the like). Some services may require an identification of the media content. This identification may be globally unique to maximize its benefit; (e.g., to be able to use services common to several publishers).

Some forms of content identification may be included in an MPD. In particular, a content instance ID, describing a particular instance of a MPD and its associated media data, may be included in the MPD, or a content ID, describing the media content independently from its encoding or MPD.

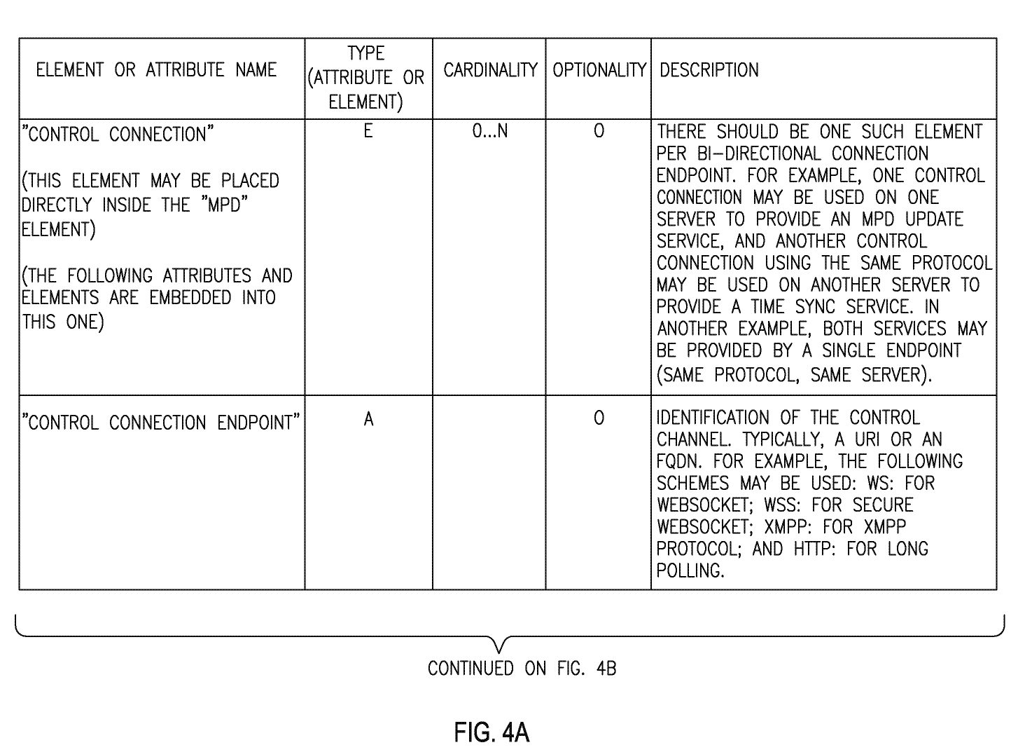

FIGS. 4A and 4B show MPD element or attribute names and descriptions. After processing the MPD, the WTRU 205 may decide to connect to the provided control connection end point. Typically, the WTRU 205 may leave this connection open, and use the appropriate protocol to register with the desired service IDs. The MPD update event service may signal all registered WTRUs that a new update of the MPD is available and may be fetched.

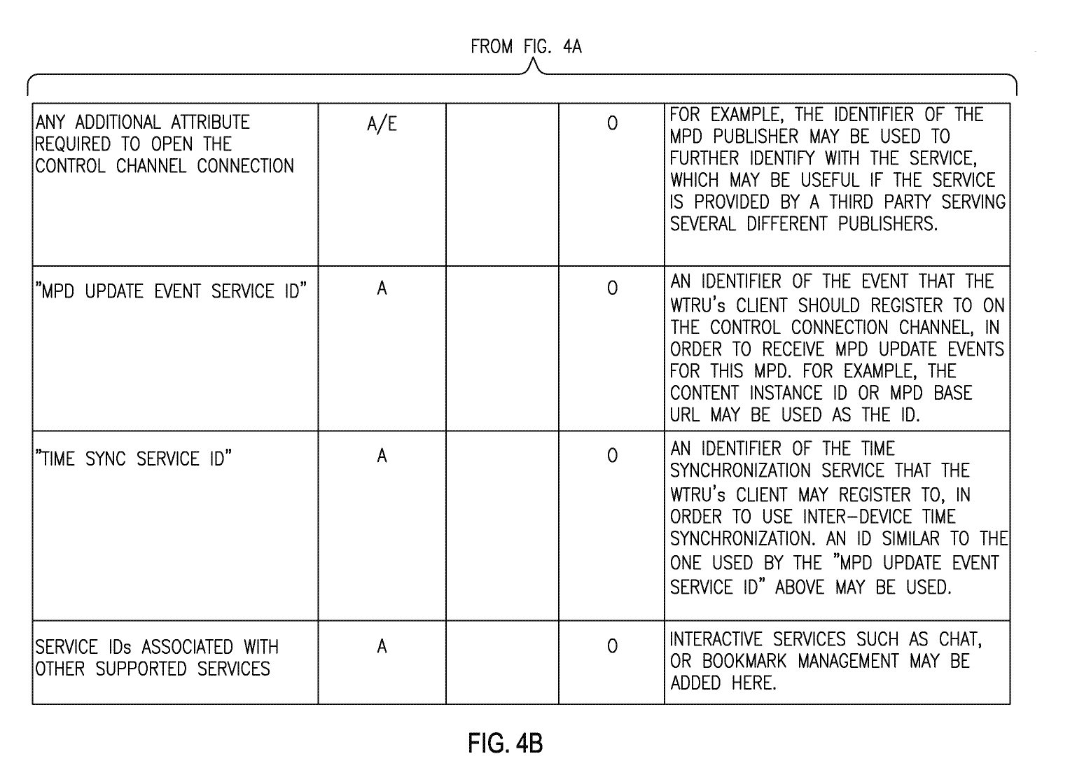

FIG. 5 shows a signal flow diagram of an example procedure for establishing communication and updating an MPD in a wireless communication system 500 including a WTRU 505 having an adaptive HTTP streaming client, a media HTTP server 510, an MPD HTTP server 515, a publisher 520 and an event server 525. Two distinct HTTP servers are represented to deliver media and metadata (MPD). Nevertheless, the same HTTP server may also be used to deliver both types of data.

As shown in FIG. 5, the WTRU 505 may obtain an MPD from an HTTP by transmitting an MPD GET request message 530 to the MPD HTTP server 515 which, in turn, provides the MPD to the WTRU 505 in a GET response message 535. The URI or FQDN of the MPD may be obtained from a number of sources, including a web portal. The WTRU 505 may then analyze the MPD (538) and obtain the identification, (e.g., a URI or an FQDN), of the event server 525. As a result, the client in the WTRU 505 may open a control connection with the event server 525 and register to receive MPD update events from the event server 525 (540). The client in the WTRU 505 may then begin downloading segments from the media HTTP server 510 (545, 550).

While the client in the WTRU 505 continues to periodically fetch (i.e., download) media segments for continuous streaming, the publisher 520 may update the media delivered by the media HTTP server 510 (555). For example, in the case of a live show, the publisher 520 may add new segments containing recently produced content. In order to make the segments available to an end user, the publisher 520 may update the MPD on the MPD HTTP server 515 (560) and notifies the event server 525 of this change by sending an MPD update signal 565. Since the WTRU 505 registered to receive this event, the event server 525 may deliver an MPD update signal 570 to the WTRU 505 indicating that the MPD for this content has been updated. The WTRU 505 may then obtain the updated MPD, (as a whole or as a delta since the last version obtained by the WTRU), by sending a fetch MPD update signal 575 to the HTTP server 515.

Thus, FIG. 5 illustrates a streaming session where a WTRU's client opens a bidirectional communication channel and receives an MPD update signal 570. Note that different nodes are shown in FIG. 5 that provide media streaming, MPD delivery and event-triggered functions. Nevertheless, it is possible to have all of these functions implemented by a single node. The MPD update signal 570 may contain additional information, such as MPD locations. Alternately, the MPD update itself may be sent, instead of a signal to fetch the update.

All streaming related flows, (e.g., an audio system streaming the audio part of a movie, and a TV streaming the video part of the same movie), may connect to the same control connection point, and register with the time synchronization service using information elements (IEs) These IEs may include a group identity (ID) IE, (which may enable matching synchronized flows together), a presentation time offset (PTO) IE, and a synchronization tolerance IE.

A group ID IE may identify flows that are being synchronized together. A PTO IE may be used to ensure that synchronization, (e.g., playback timing), occurs for a plurality of WTRU. A PTO may calculated as follows:

PTO=Current_playback_time−Current_timestamp, Equation (1)

where the Current_playback_time may be based on a wall clock time when performing the playback of a first byte of a current segment being played, and the Current_timestamp may be a timestamp of the segment, relative to the beginning of the media presentation. PTO calculation may be performed at an interval, and/or at all media segments. Also, the PTO calculation may be performed at random access points (RAPs).

The synchronization tolerance IE may be optionally provided to a plurality of WTRUs to enable triggering corrective actions when a flow goes out of sync. All WTRUs using the same group ID may be synchronized together. The group ID may be unique (within the scope of the service), and may be configured in the devices, (e.g., for a group of devices often used together). The group ID may also be set by a third party entity using various protocols.

The PTO IE may be calculated during playback, by using the current wall clock of the device when playing the beginning of a media segment. The timestamp is the start time of the media segment, which is obtained directly or indirectly from the metadata associated with the media. The goal of the time synchronization procedure is to keep the PTO constant (within a given tolerance) across all synchronized devices.

The synchronization tolerance is used by the WTRUs to detect out-of-sync situations. When the WTRU detects it is out of sync, it may request a corrective action by the time synchronization service.

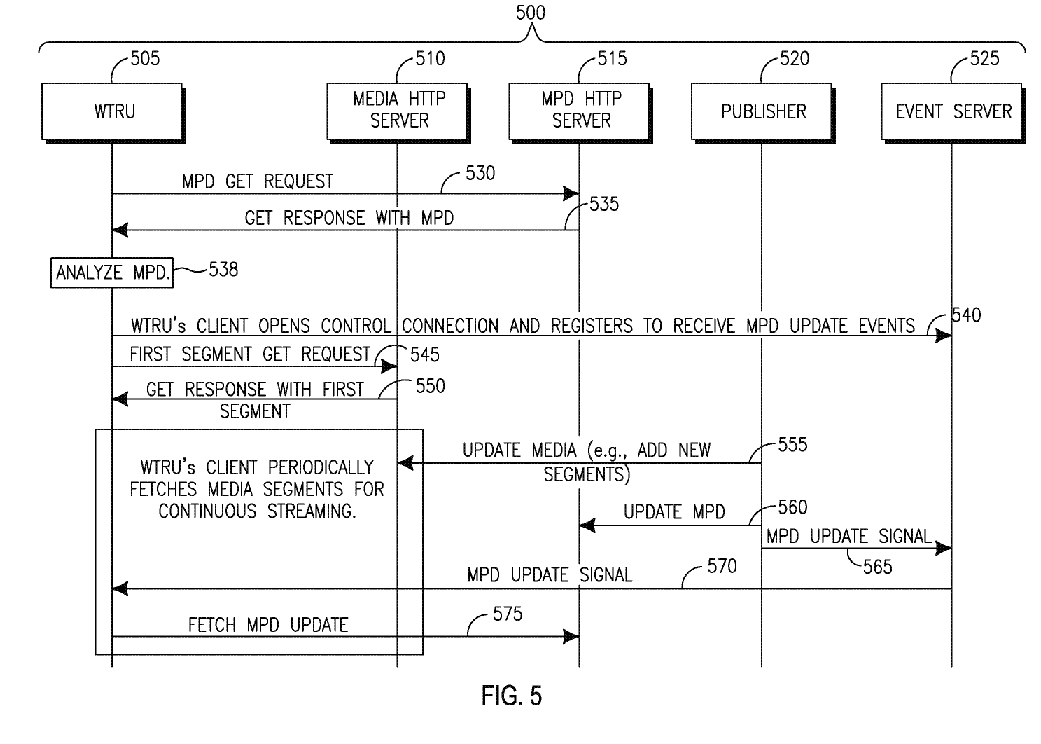

FIG. 6 shows a signal flow diagram of an example procedure using two WTRUs that register to a time synchronization service with the same group ID in a wireless communication system 600 including WTRUs 605 and 610, (each of which include an adaptive HTTP streaming client), a media HTTP server 615, an MPD HTTP server 620, a publisher 625 and a time synchronization service 630. An adaptive HTTP video stream 635 is established between the WTRU 605 and the media HTTP server 615, and an adaptive HTTP audio stream 640 is established between the WTRU 610 and the media HTTP server 615. It is desired to have the playback synchronized for both of the WTRUs 605 and 610. As a prerequisite, WTRUs 605 and 610 establish a shared knowledge of a group identity (ID) “G1”. The mechanism to share this knowledge is not represented and may be implemented using a number of methods, (e.g., pre-configuration, signalling over near-field communication, input by the end user, and the like). Moreover, the WTRUs 605 and 610 may both have the MPD of the media flow and may initiate their streaming session by downloading the MPD and then selecting a video/audio representation described in this MPD. The MPD may contain a reference to the time synchronization service 630.

The client in the WTRU 605 may open a control connection with the time synchronization service 630 referenced in the MPD, and register to the time synchronization service 630 by providing the group ID “G1”, the current presentation time offset (PTO) measured on the WTRU 605 and, optionally, a synchronization tolerance (645). The client in the WTRU 610 may open a control connection with the time synchronization service 630 referenced in the MPD, and register to the time synchronization service 630 by providing the group ID “G1”, the current PTO measured on the WTRU 610 and, optionally, a synchronization tolerance (650).

The time synchronization service 630 may use the information provided while registering the WTRUs 605 and 610 to compute a suggested PTO and a suggested synchronization tolerance, and provide the group ID, a suggested PTO and a suggested synchronization tolerance to the WTRUs 605 and 610 (655, 660). When applicable, (i.e., when the suggested PTO is different than the current PTO on the WTRUs 605 and 610), the WTRUs 605 and 610 may adjust their playback to match the suggested PTO. From this point on, the WTRUs 605 and 610 may be part of a time synchronization control session (665, 670).

The time synchronization service 630 may provide information for the WTRUs to adjust their playback by maintaining a time synchronization control session state with the WTRUs 605 and 610 (665, 670).

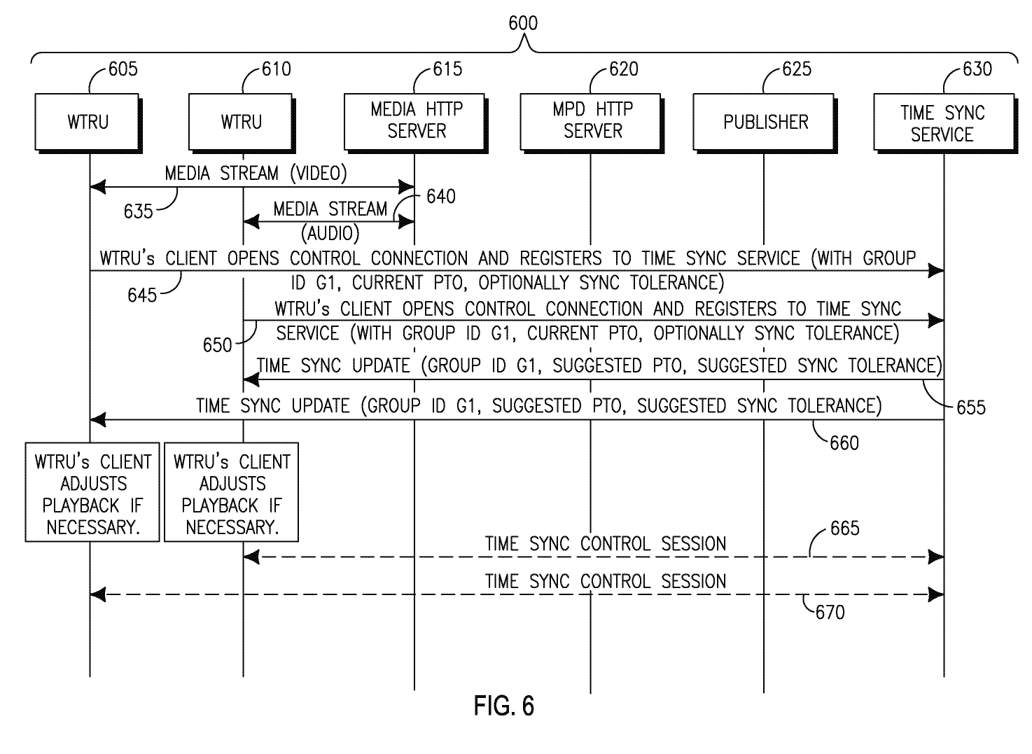

FIG. 7 shows a signal flow diagram of an example procedure for re-synchronizing WTRUs after the procedure of FIG. 6 is performed. After the adaptive HTTP video stream 635 and the adaptive HTTP audio stream 640 are established, and time synchronization control sessions 665 and 670 begin, one of the synchronized WTRUs 605 and 610 may detect that it is out-of-sync, (e.g., it incurs a large network delay and its playout time offset is greater than the suggested PTO). In the example shown in FIG. 7, the client in the WTRU 610 may detect that its playback is out-of-sync with the playback of the client in the WTRU 605 (705). This detection of out-of-sync playback may occur if the difference between a local PTO measurement and the last suggested PTO received from the time synchronization service 630 is larger than the synchronization tolerance (also received from the time synchronization service 630). For example, the out-of-sync playback may be due to lags in the software execution of the WTRU's client, or due to lags in the network. When the WTRU 610 detects the out-of-sync playback, it may transmit an out-of-sync message 710 to the time synchronization service 630 including the local PTO measurement, which may re-compute a PTO and transmit update messages 715 and 720 with a new suggested PTO and a new suggested synchronization tolerance to the WTRUs 605 and 610, respectively. The clients in the WTRUs 605 and 610 may then adjust their playback based on the new suggested PTO and the new suggested synchronization tolerance if necessary. Thus, when the WTRUs 605 and 610 cannot play a media segment at a suggested time, their clients may provide information to the time synchronization service 630 to correct the situation.

An MPD may reference a number of services related to the media stream, such as chat, cross-device bookmarks, session sharing and transfer, instant messaging (IM) and other interactive and social networking services. Note that all services do not need to be unique per MPD. For example, a publisher may provide one common service ID to access a unique IM service for this publisher's clients. In this case, the same service ID may be included in more than one MPD.

Connection to the control channel may use secure versions of the supported protocols. Alternatively, various deployment options may be used, such as a third party operated external server, a dedicated server controlled by the publisher, or a function collocated with the MPD delivery server. Instead of using media segments, which will typically be cached by intermediate nodes, messages sent via a new control communication channel are interactive and may be marked as non-cacheable when appropriate (e.g., when using HTTP/1.1).

In an alternate embodiment, control point and service identification may be obtained from sources other than the MPD, such as the web portal of the publisher. The format may be, for example, an XML representation of available services.

The following embodiments describe additional information that should be added in the MPD and optionally into the media files as well. These are reference IDs that may be useful to refer to a particular stream for the purpose of a service. For example, an end-user client program may connect to the MPD update service, and register for MPD update events for one particular stream instance. Alternatively, an end-user client program may connect to a service providing access to other stream instances for the same content. In this case, the client program may provide an identifier to the content itself, (e.g., the movie “Avatar”), not a particular stream instance, (e.g., the movie “Avatar” provided for steaming by Netflix).

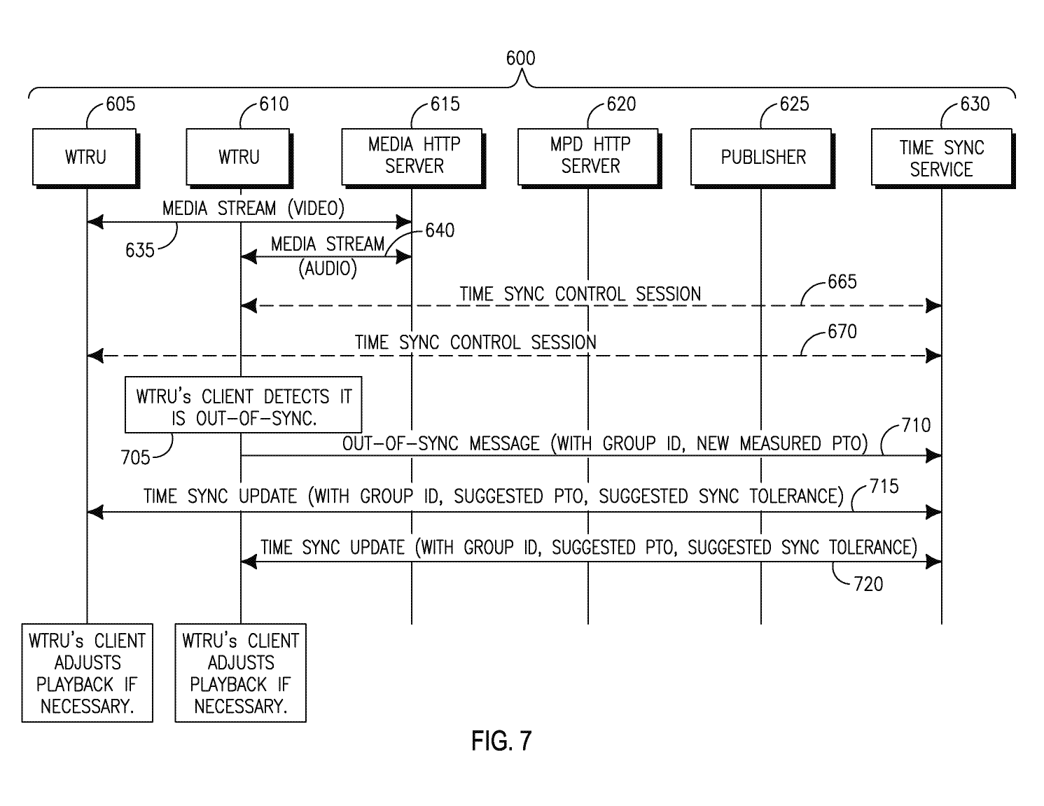

FIG. 8 shows an MPD element or attribute name and description of a content instance ID attribute. The Content Instance ID Attribute identifies the specific MPD it is included in, as well as the media content referred to in this MPD.

The content instance ID may be globally unique. For example, a string built using the publisher domain name, followed by a date, (e.g., the domain name was owned by the publisher at this date), and finally an ID attributed by the publisher and unique within this context. Note that in this case, the publisher is not necessarily the original publisher of the content; it is the service provider who makes the media available online. Other schemes leading to a globally unique content Instance ID may be used. The content Instance ID may be also be encoded in the associated media file(s), and used to identify all assets related to one particular stream (e.g., MPD and media file(s)), to refer to them when using a service on a control channel. The content instance ID may be used for the identification of the media content in content delivery network (CDN) interconnection scenarios, (i.e., it allows for a non-ambiguous reference to all related media assets, when requesting their transfer to a CDN).

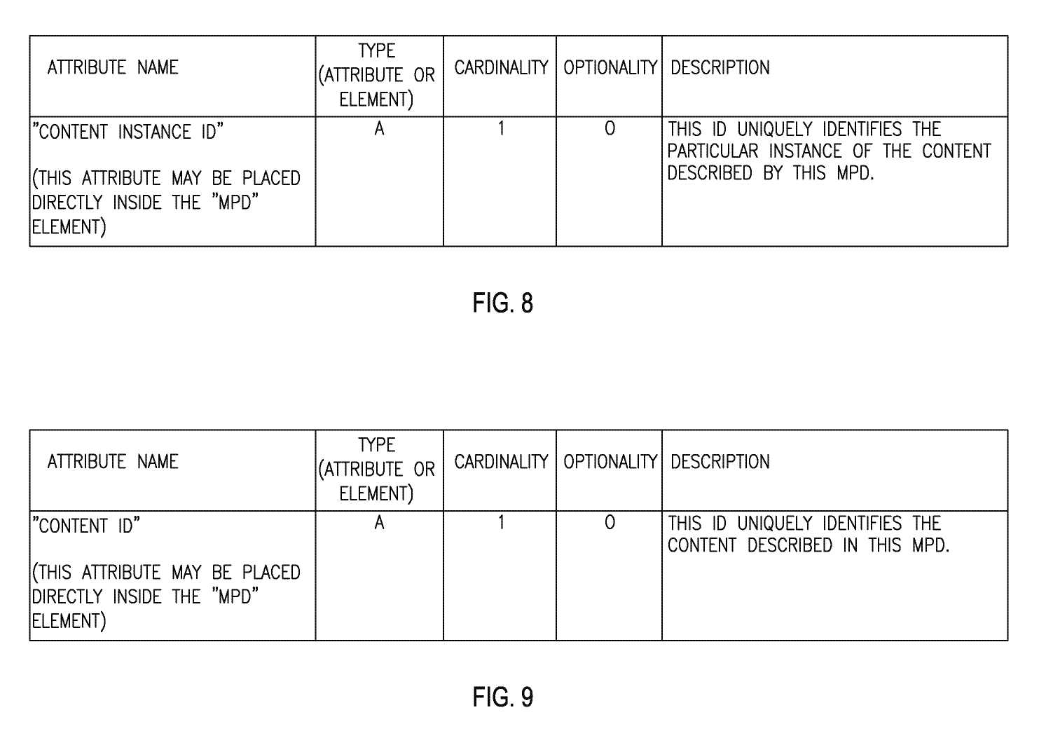

FIG. 9 shows an MPD element or attribute name and description of a content ID attribute. The Content ID Attribute identifies the media content itself, independently from any particular stream instance. For example, an encoding similar to the content instance ID encodings described previously may be used. The content ID may include a publisher ID. In this case, this publisher is the original publisher of the content, (e.g., a movie publishing company). Alternatively, an ID maintained by a global registry may be used for content ID, (e.g., international standard book number for books). This ID may be used to help retrieving equivalent content, from another service provider for example. It may be used in CDN interconnections as well.

One possible candidate to identify the MPD from inside the MPD itself is currently the base URI or FQDN element. Nevertheless, a content instance ID may be useful to designate potentially several instances of an MPD, (which may be accessed from different URIs or FQDNs), as long as the MPD identifies the same media. For example, the same instance ID may identify a single stream entity provided to end-customers through several CDNs. MPD update may be pushed to different servers, (accessed using different base URI or FQDN), but need only be signaled once, on a single common service.

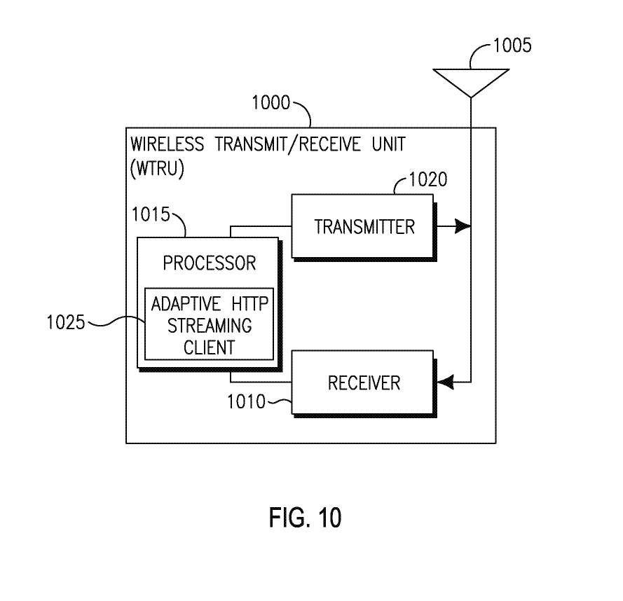

FIG. 10 shows an example block diagram of a WTRU 1000 used in the procedures of FIGS. 5-7. The WTRU 1000 may include at least one antenna 1005, a receiver 1010, a processor 1015 and a transmitter 1020. The processor 1015 may include an adaptive HTTP streaming client 1025.

The transmitter 1020 may be configured to transmit an HTTP request message via the at least one antenna 1005. The receiver 1010 may be configured to receive an HTTP response message including metadata requested by the HTTP request message, and a metadata update signal provided by the metadata update service, via the at least one antenna 1005. The adaptive HTTP streaming client 1025 in the processor 1015 may be configured to register with at least one server to establish a metadata update service based on information included in the metadata. The client 1025 may be configured to analyze the MPD and obtain the identification, (e.g., FQDN), of an event server and open a control connection with the event server via the transmitter 1020 and the at least one antenna 1005 to register to receive MPD update events from the event server via the receiver 1010. The client 1025 may provide a group ID, a current PTO, and a synchronization tolerance via the control connection. The client 1025 may be further configured to download segments from a media HTTP server. The receiver 1010 may be further configured to receive an MPD update signal indicating that the MPD has been updated. The client 1025 may be further configured to transmit a fetch MPD update signal via the transmitter 1020 and the at least one antenna 1005 to obtain the updated MPD.

The receiver 1010 may be further configured to receive a time synchronization update signal via the at least one antenna 1005 including the group ID, a suggested PTO and a suggested synchronization tolerance. The client 1025 may be further configured to adjust playback based on at least one of the suggested PTO and the suggested synchronization tolerance.

The client 1015 may be further configured to locally measure its PTO and detect whether its playback of HTTP streamed media is out-of-sync based on the locally measured PTO. The client 1015 may further be configured to monitor the difference between the locally measured PTO and a suggested PTO previously received from a time synchronization service, and determine whether that difference is larger that a synchronization tolerance received from the time synchronization service. The transmitter 1020 may be further configured to transmit an out-of-sync message to the time synchronization service via the at least one antenna 1005 when the WTRU is out-of-sync.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method of a wireless transmit/receive unit (WTRU) updating metadata, the method comprising:
the WTRU transmitting a hypertext transport protocol (HTTP) request message;
the WTRU receiving an HTTP response message including metadata requested by the HTTP request message;
the WTRU registering with at least one server to establish a metadata update service based on information included in the metadata; and
the WTRU fetching updated metadata in response to receiving a metadata update signal provided by the metadata update service.

2. The method of claim 1 wherein the information identifies a uniform resource identifier (URI) or a fully qualified domain name (FQDN) associated with an event server used to provide the metadata update service.

3. The method of claim 1 wherein the metadata is a media presentation description (MPD).

4. The method of claim 1 further comprising:
the WTRU registering with at least one server to establish a time synchronization service by providing initial time synchronization information including a current presentation time offset (PTO);
the WTRU receiving a first message from the time synchronization service including updated time synchronization information;
the WTRU determining whether or not to adjust its playback of HTTP streamed media based on the updated time synchronization information; and
the WTRU participating in a time synchronization control session with the time synchronization service.

5. The method of claim 4 wherein the initial time synchronization information further includes a synchronization tolerance.

6. The method of claim 4 wherein the updated time synchronization information includes a suggested PTO and a suggested synchronization tolerance.

7. A method of a wireless transmit/receive unit (WTRU) updating metadata, the method comprising:
the WTRU transmitting a hypertext transport protocol (HTTP) request message;
the WTRU receiving an HTTP response message including a class status code; and
the WTRU determining whether or not to fetch updated metadata in response to receiving the HTTP response message.

8. The method of claim 7 wherein the class status code indicates an informational class that instructs the WTRU to download a media presentation description (MPD) update, and the WTRU determines to fetch the MPD update on a condition that the MPD update is more recent than the WTRU's current MPD.

9. The method of claim 8 wherein the HTTP response message indicates a recommended download location of the MPD update.

10. The method of claim 7 wherein the class status code indicates a success class.

11. The method of claim 7 wherein the class status code indicates a redirection class.

12. The method of claim 7 wherein the class status code indicates a WTRU error class.

13. The method of claim 7 wherein the class status code indicates a server error class.

14. A method of a wireless transmit/receive unit (WTRU) updating metadata, the method comprising:
the WTRU requesting a metadata from a hypertext transport protocol (HTTP) server;
the WTRU receiving the metadata from the HTTP server; and
the WTRU registering with an event server to receive metadata update events based on information included in the metadata received from the HTTP server.

15. The method of claim 14 wherein the information identifies a uniform resource identifier (URI) or a fully qualified domain name (FQDN) associated with an event server used to provide the metadata update service.

16. The method of claim 14 wherein the metadata is a media presentation description (MPD).

17. The method of claim 14 further comprising:
receiving a metadata update signal from the event server indicating that updates to the metadata are available; and
transmitting a fetch metadata update signal to the HTTP server to obtain the updated metadata.

18. A wireless transmit/receive unit (WTRU) comprising:
a transmitter configured to transmitting a hypertext transport protocol (HTTP) request message;
a receiver configured to receive an HTTP response message including metadata requested by the HTTP request message; and
an adaptive HTTP streaming client configured to register with at least one server to establish a metadata update service based on information included in the metadata, and fetch updated metadata in response to receiving a metadata update signal provided by the metadata update service.

19. The WTRU of claim 18 wherein the information identifies a uniform resource identifier (URI) or a fully qualified domain name (FQDN) associated with an event server used to provide the metadata update service.

20. The WTRU of claim 18 wherein the metadata is a media presentation description (MPD).
